(19) United States
(12) Patent Application Publication
(10) Pub. No.: US 2018/0272539 A1
(43) Pub. Date: Sep. 27, 2018

(54) INFORMATION PROCESSING APPARATUS, SYSTEM, INFORMATION PROCESSING METHOD, AND MANUFACTURING METHOD

(71) Applicant: CANON KABUSHIKI KAISHA, Tokyo (JP)

(72) Inventor: Tsuyoshi Kitamura, Utsunomiya-shi (JP)

(21) Appl. No.: 15/927,706

(22) Filed: Mar. 21, 2018

(30) Foreign Application Priority Data
Mar. 24, 2017 (JP) 2017-059688

(51) Int. Cl. B25J 9/16; G01B 11/00

(52) U.S. Cl. CPC B25J 9/1697; Y10S 901/47; B25J 9/1687; G01B 11/005

(57) ABSTRACT

The position and orientation of a pallet in a robot coordinate system are obtained based on the result of measurement of position and orientation of the pallet by a measurement apparatus moving at a first speed and the position and orientation of a hand in a robot coordinate system acquired during the measurement. The position and orientation of work in the robot coordinate system are obtained based on the result of measurement of positions and orientations of the pallet and the work by the measurement apparatus moving at a second speed and the position and orientation of the pallet in the robot coordinate system.

### BACKGROUND OF THE INVENTION

### Field of the Invention

The present invention relates to a technique for measuring the position and orientation of a measurement target.

### Description of the Related Art

A machine vision as a kind of three-dimensional shape measurement apparatus refers in particular to an application of computer vision in the manufacturing industry. For example, operating a robot based on the result of measurement of components by the machine vision makes it possible to implement various processes such as grasping and assembly. To operate the robot on a measurement target, the position and orientation of the measurement target are generally calculated in a coordinate system with reference to the seat of the robot, that is, the robot coordinate system. It is thus necessary to acquire the accurate position and orientation of the measurement target in a vision coordinate system measured by the machine vision and obtain the machine vision at the time of measurement and the accurate positions and orientations of a hand and a robot flange of which the positions and orientations relative to the machine vision are known. In the following description, these positions and orientations will be collectively robot position and orientation (the position and orientation of the robot). The robot position and orientation described below includes a mechanism included in the robot such as a flange or the positions and orientations of the vision and the hand of which positions and orientations relative to the mechanism are ensured in the robot coordinate system.

As a mode of using the machine vision, there exists an on-hand machine vision system in which a machine vision is installed in a robot. In this mode, the machine vision can be moved to arbitrary places for measurement, which provides the advantages that the measuring range is flexible as compared to the case where the machine vision is fixedly installed on a scaffold or the like, and the necessary space of the system can be saved. Further, there is known a method for machine-vision measurement with a robot driven in an on-hand system. For example, Japanese Patent No. 4837116 describes this technique which is obviously superior to measurement systems with a stationary robot, from the viewpoint of throughput as an important index of performance of machine vision systems.

In the measurement process performed by the machine vision, the position and orientation of a measurement target are calculated by shooting the measurement target and processing the shot image. The time necessary for image shooting has at least a time width of camera exposure. Considering the characteristics of image processing, this measurement time is frequently assumed to be an intermediate time during the exposure in moving measurement. For example, in order to calculate the position and orientation of a measurement target in the robot coordinate system based on the position and orientation of the measurement target measured during moving measurement, it is important to acquire the accurate position and orientation of the moving robot at the intermediate time during the exposure.

### SUMMARY OF THE INVENTION

Embodiments of the present invention include a first obtaining unit that, based on the result of measurement of position and orientation (or direction, aspect, tilt) of a stationary object by a sensor attached to a robot moving at a first speed and the position and orientation of the robot in a reference coordinate system acquired during the measurement, obtains the position and orientation of the stationary object in the reference coordinate system, and a second obtaining unit that, based on the result of measurement of positions and orientations of the stationary object and a target object by the sensor attached to the robot moving at a second speed higher than the first speed and the position and orientation of the stationary object obtained by the first obtaining unit, obtains the position and orientation of the target object in the reference coordinate system.

Further features of the present invention will become apparent from the following description of exemplary embodiments (with reference to the attached drawings).

### BRIEF DESCRIPTION OF THE DRAWINGS

FIG. 1 is a diagram illustrating a configuration example of a machine vision system 1.

FIG. 2 is a block diagram illustrating a hardware configuration example of a computer device 199.

FIG. 3 is a flowchart of processing performed by an information processing apparatus 6;

FIG. 4 is a diagram illustrating a configuration example of the machine vision system 1.

FIG. 5 is a diagram illustrating a control system including a measurement apparatus and a robot arm.

FIG. 6 is a diagram illustrating a configuration example of the machine vision system 1.

FIG. 7 is a diagram illustrating a configuration example of the machine vision system 1.

FIG. 8 is a flowchart of processing performed by the information processing apparatus 6.

FIG. 9 is a flowchart of processing performed by the information processing apparatus 6.

FIG. 10 is a flowchart of processing performed by the information processing apparatus 6.

### DESCRIPTION OF THE EMBODIMENTS

In some situations, however, the robot position and orientation at the above-mentioned measurement time cannot be acquired or can be acquired with lack of accuracy. For example, it has been observed in some cases that, when the robot is moving at a high speed, the position and orientation of the robot cannot be acquired. The position and orientation of the robot are acquired by a robot controller receiving a trigger at the time of image shooting, for example. In the foregoing case, however, it is presumed that, before the information on the position and orientation acquired upon receipt of the trigger by the robot controller was completely written in a memory, the robot controller received the next trigger. Regardless of this example, when taking various parameters such as moving speed, exposure time, and computer performance into account, it is considered to be difficult to manage or control the timing for acquiring surely the position and orientation of the robot.

Even if the robot position and orientation can be acquired, the accuracy of the position and orientation may be an issue. For example, it is difficult to control completely the time of processing in the robot controller independently of measurement conditions, and there arises a time lag between the time of image shooting and the time of acquiring the robot position and orientation from the robot controller. Accordingly, there exists an error between the true value of the robot position and orientation at the time of image shooting and the robot position and orientation information acquired from the robot controller. For example, when the moving speed of the robot is assumed as 1 m/SEC and the time lag resulting from the time of processing in the robot controller is assumed to be 200 μSEC, the robot position information has an error of 200 μm. This error amount leads directly to an error in the robot position during such operations as grasping and assembly, which may cause the failure of the various operations as the purposes of the machine vision system.

Japanese Patent No. 4837116 discloses a technique for acquiring the accurate robot position at the moment of image shooting by acquiring the position of the arm end at the times before and after the image shooting and calculating the position of the arm end at the time of image shooting based on the acquired position and the time of image shooting. However, the foregoing issue is due to that the time of image shooting cannot be acquired or can be acquired with lack of accuracy. Accordingly, the technique disclosed in Japanese Patent No. 4837116 is effective in the case where the accurate time of image shooting can be acquired but does not constitute a measure against the foregoing issue.

In addition, there is known a technique disclosed in Japanese Patent Laid-Open No. 2010-20799 for acquiring the accurate robot position and orientation. Japanese Patent Laid-Open No. 2010-20799 proposes a technique as described below for improving a low accuracy of absolute position of a robot device. According to this technique, a reference measurement target in a known absolute position is measured to acquire the absolute position of the measurement apparatus at the time of measurement of the reference measurement target. Then, a measurement target is measured by acquiring the amount and direction of movement of the measurement apparatus from the position where the reference measurement target was measured to the position where the measurement target was measured after the movement, and acquiring the absolute position of the measurement apparatus after the movement. In this case, a micro-positioning device acquires the amount and direction of movement of the measurement apparatus. The micro-positioning device is described as a general-purpose robot or a device attached to that robot. However, it is very difficult for the micro-positioning device to acquire the amount and direction of movement of the measurement apparatus at specific timing for the fast-moving robot.

Embodiments of the present invention are devised in light of the foregoing problems and provide a technique for determining the accurate position and orientation of a measurement target during movement.

Embodiments of the present invention will be described below with reference to the accompanying drawings. The embodiments described below are examples of carrying out the present invention, which are specific examples of configurations described in the claims.

### First Embodiment

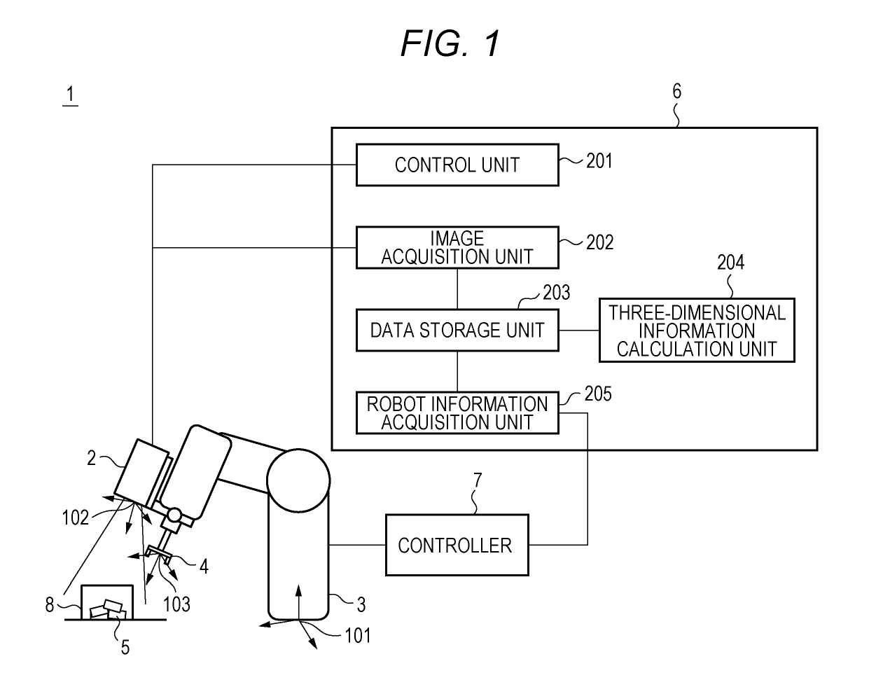

First, a configuration example of a machine vision system 1 according to a first embodiment will be described with reference to FIG. 1. In a real space (a desktop or the like), as illustrated in FIG. 1, a pallet 8 is placed as an example of a container that is a stationary object (reference object) unchanged in position and orientation. On the pallet 8, work 5 such as components is located (contained) as a grasping target (target object) of a hand 4 (part of a robot arm) of a robot (robot arm) 3. The work 5 is located in bulk on the pallet 8, for example. The work 5 may not be necessarily located on the pallet 8 but may be located near the pallet 8 in such a manner as to fall together with the pallet 8 within the measuring range of a measurement apparatus (machine vision) 2.

The measurement apparatus 2 is rigidly attached to the robot 3 via a mounter or the like. The measurement apparatus 2 is a kind of three-dimensional shape measurement apparatus that is intended to obtain three-dimensional information (three-dimensional shape and three-dimensional position and orientation) of a measurement target. There exist a large number of three-dimensional shape measurement methods. In the first embodiment, a pattern light projection measurement method is employed. According to this method, a projection system (projection apparatus) projects a predetermined projection pattern onto a measurement target, an imaging system (imaging apparatus) shoots the measurement target on which the projection pattern is projected, so that three-dimensional information of the measurement target can be determined from the image obtained by the image shooting. There are various types of projection patterns. In the first embodiment, a pattern with dots on lines is employed. With this pattern, coordinate information of the dots detected from the shot image indicates correspondences between the lines in that pattern and lines on a mask pattern. Accordingly, the three-dimensional information of the whole measurement target can be acquired by single image shooting. The projection system and the imaging system of the measurement apparatus 2 are controlled by an information processing apparatus 6 (a control unit 201).

For the measurement apparatus 2, there exists a vision coordinate system 102 with reference to the measurement apparatus 2. The position and orientation of the work 5 determined based on the image shot by the measurement apparatus 2 constitute the position and orientation in the vision coordinate system 102. For example, the vision coordinate system 102 is a coordinate system in which the focal position of an optical system included in the imaging system of the measurement apparatus 2 is set at an origin point, a z axis is oriented in the imaging direction of the measurement apparatus 2, and x and y axes are orthogonal to the z axis.

The robot 3 has a hand 4 for grasping the work 5, rigidly attached to the leading end. The robot 3 can grasp the work 5 by the hand 4 and move the work 5 in desired position and orientation to assemble the grasped work 5 into another object. A typical example of the robot 3 is a six-axis multi-joint robot that is widely used in sorting and assembling processes of components and the like in the manufacturing industry. For the robot 3, there exists a robot coordinate system 101 with reference to the robot 3. For example, the robot coordinate system 101 is a coordinate system in which a prescribed position on the seat of the robot 3 is set at an origin point and three axes orthogonal to one another at the origin point are set as x, y, and z axes. The robot coordinate system 101 is a reference coordinate system and thus can be provided at any place in a real space as far as the coordinate system takes position and orientation relative to the robot 3. For the hand 4, there exists a hand coordinate system 103 with reference to the hand 4. For example, the hand coordinate system 103 is a coordinate system in which the position of the root portion of the hand 4 is set at an origin point, a z axis is oriented in the direction of the arm to which the hand 4 is attached, and two axes orthogonal to the z axis are set as x and y axes. Since the measurement apparatus 2 is also fixedly arranged on the robot 3 as described above, there is a fixed relationship in relative position and orientation between the measurement apparatus 2 (the vision coordinate system 102) and the hand 4 (the hand coordinate system 103). The relationship in relative position and orientation between the measurement apparatus 2 (the vision coordinate system 102) and the hand 4 (the hand coordinate system 103) is determined at the time of calibration and registered in the information processing apparatus 6 (a data storage unit 203). The hand coordinate system 103 is not limited to the coordinate system with reference to the hand 4 but may be set at any place in the arm portion of the robot 3.

A controller 7 performs the control of the robot 3, for example, the control operation for controlling the position and orientation of the hand 4 by controlling the positions and orientations of the arms of the robot 3. In order for the hand 4 to grasp the work 5, it is necessary to provide the controller 7 with the position and orientation of the work 5 in the robot coordinate system 101. In the embodiment, the accurate position and orientation of the work 5 in the robot coordinate system 101 at the time of shooting an image by the measurement apparatus 2 are determined from the position and orientation of the work 5 in the vision coordinate system 102 determined from the shot image, and are provided to the controller 7. In the embodiment, the information processing apparatus 6 calculates the position and orientation of the work 5 in the robot coordinate system 101 and provides the same to the controller 7.

Next, the information processing apparatus 6 will be described. The control unit 201 is intended to control the entire operations of the information processing apparatus 6. An image acquisition unit 202 acquires the image shot by the measurement apparatus 2 (imaging apparatus). The data storage unit 203 saves data necessary for the information processing apparatus 6 to execute various processes. A three-dimensional information calculation (obtaining) unit 204 performs various processes to calculate (obtain) three-dimensional information on the work 5 seen in the image shot by the measurement apparatus 2. A robot information acquisition unit 205 acquires the position and orientation of the hand 4 in the robot coordinate system 101 from the controller 7.

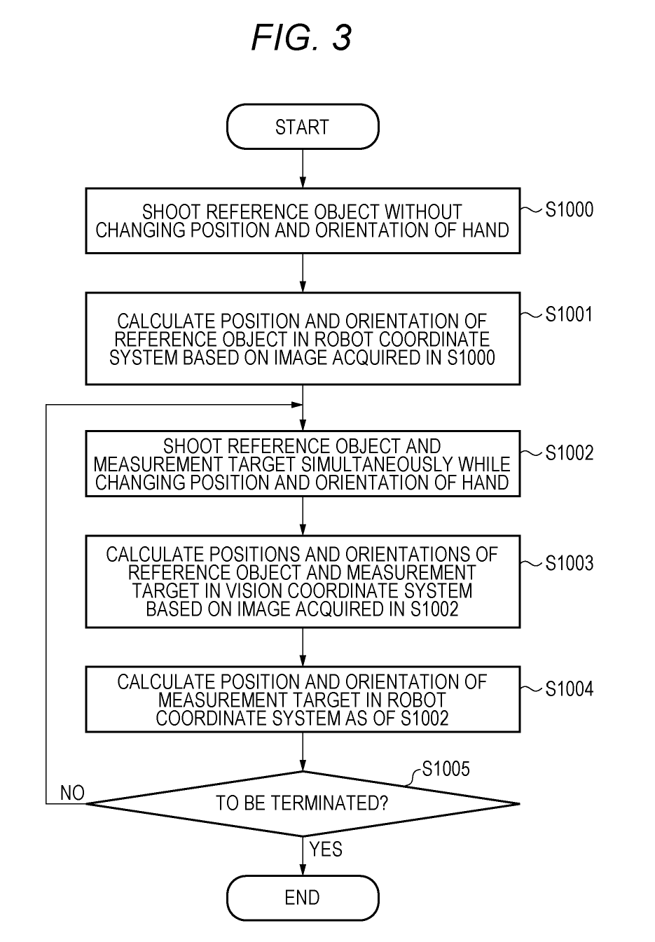

Next, the process performed by the information processing apparatus 6 to calculate the accurate position and orientation of the work 5 in the robot coordinate system 101 from the image shot by the measurement apparatus 2 while changing the positions and orientations of the arms of the robot 3 will be described with reference to the flowchart of FIG. 3. In the process according to the flowchart of FIG. 3, the pallet 8 is fixedly arranged and is unchanged in position and orientation between the steps until step S1002 and the subsequent steps.

### <Step S1000>

First, the controller 7 fixes the position and orientation of the hand 4 such that the pallet 8 falls within the ranges of pattern projecting and image projecting by the measurement apparatus 2 (that is, the controller 7 fixes the position and orientation of the measurement apparatus 2). In this step, the work 5 may not be arranged on or near the pallet 8. Then, the measurement apparatus 2 outputs to the information processing apparatus 6 the shot image of the pallet 8 on which the projection pattern is projected. The image acquisition unit 202 acquires the shot image sent by the measurement apparatus 2 and stores the same in the data storage unit 203.

The robot information acquisition unit 205 also acquires from the controller 7 the position and orientation of the hand 4 in the robot coordinate system 101 while the pallet 8 is shot with the hand 4 fixed in position and orientation (the measurement apparatus 2), and stores the same in the data storage unit 203.

### <Step S1001>

The three-dimensional information calculation (obtaining) unit 204 calculates (obtains) the position and orientation of the pallet 8 in the vision coordinate system 102 from the shot image stored in the data storage unit 203 in step S1000. There is known a technique for calculating (obtaining) the position and orientation of a measurement target from the shot image of the measurement target on which a projection pattern is projected. For example, the three-dimensional shape of the measurement target is measured by calculating distance information at individual pixel positions in the shot image based on the principle of triangulation, and the three-dimensional shape is compared to model information of the measurement target stored in advance in the data storage unit 203 to determine the position and orientation of the measurement target. A matrix representing the thus determined position and orientation of the pallet 8 in the vision coordinate system 102 will be expressed as Tr_{VP(stop)}.

Meanwhile, the relationship in relative position and orientation between the vision coordinate system 102 and the hand coordinate system 103, that is, the position and orientation of the vision coordinate system 102 with reference to the hand coordinate system 103 (the position and orientation of the measurement apparatus 2 in the hand coordinate system 103) is predetermined at the time of calibration. The predetermined position and orientation are registered in the data storage unit 203. A matrix representing the position and orientation of the vision coordinate system 102 with reference to the hand coordinate system 103 (the position and orientation of the measurement apparatus 2 in the hand coordinate system 103) will be expressed as Tr_{HV}.

A matrix representing the position and orientation of the hand 4 in the robot coordinate system 101 acquired by the robot information acquisition unit 205 from the controller 7 in step S1000 will be expressed as Tr_{RH(stop)}.

At that time, the three-dimensional information calculation unit 204 calculates a matrix Tr_{RP} representing the position and orientation of the pallet 8 in the robot coordinate system 101 at the time of image shooting in step S1000 according to the following equation (1):

Tr_{RP}=TR_{RH(stop}·Tr_{HV}·Tr_{VP(stop)} (1)

In this manner, in steps S1000 and S1001, the position and orientation of the pallet 8 are measured with the measurement apparatus 2 fixed in position and orientation. According to this method, it is possible to acquire the accurate position and orientation of the hand 4 at the time of measurement, thereby to determine the accurate position and orientation Tr_{RP} of the pallet 8 in the robot coordinate system 101 at the time of measurement. As a result, the accurate value of Tr_{RP} can be obtained within the ranges of measurement error and positioning error of the robot 3 in the stationary state. Then, the three-dimensional information calculation unit 204 stores the thus determined value of Tr_{RP} in the data storage unit 203.

The value of Tr_{RP} determined in steps S1000 and S1001 is used in step S1002 and the subsequent steps to determine the position and orientation of the work 5 in the robot coordinate system 101.

<step S1002>

In step S1002 and the subsequent steps, the work 5 is arranged on or near the pallet 8, and the position and orientation of the work 5 in the robot coordinate system 101 are measured with changes in the position and orientation of the hand 4 (with movement of the hand 4). The movement of the hand 4 also means the movement of the measurement apparatus 2. When the hand 4 interferes with the pallet 8 or when the information processing apparatus 6 recognizes wrongly the position and orientation of the work 5 and makes a move based on the result of the recognition to cause unexpected interference with the work 5, the production line may need to be stopped due to displacement of the hand 4 or the like. Accordingly, the machine vision system 1 generally has various functions to prevent occurrence of such interference so that the position and orientation of the pallet 8 can be regarded as unchanged unless some irregular event occurs.

As described above, the controller 7 changes the position and orientation of the hand 4. The controller 7 changes the position and orientation of the hand 4 by altering the positions and orientations of the arms of the robot 3 such that both the pallet 8 and the work 5 fall within the ranges of pattern projection and image shooting by the measurement apparatus 2. In step S1002, while the controller 7 changes the position and orientation of the hand 4, the measurement apparatus 2 projects the projection pattern onto both the pallet 8 and the work 5, and shoots both the pallet 8 and the work 5 on which the projection pattern is projected. The image obtained by the image shooting shows both the pallet 8 and the work 5 on which the projection pattern is projected. Then, the image acquisition unit 202 acquires from the measurement apparatus 2 the shot image (showing both the pallet 8 and the work 5 on which the projection pattern is projected), and stores the acquired shot image in the data storage unit 203.

### <Step S1003>

The three-dimensional information calculation unit 204 calculates the position and orientation of the pallet 8 and the position and orientation of the work 5 in the vision coordinate system 102 from the shot image stored in the data storage unit 203 in step S1002. The method for calculating the positions and orientations of the pallet 8 and the work 5 from the shot image is the same as that in step S1001.

A matrix representing the thus determined position and orientation of the pallet 8 in the vision coordinate system 102 will be expressed as Tr_{VP(run)}, and a matrix representing the position and orientation of the work 5 in the vision coordinate system 102 will be expressed as Tr_{VW(run)}.

### <Step S1004>

The three-dimensional information calculation unit 204 calculates the following equation (2) by the use of the value of Tr_{RP} stored in the data storage unit 203 in step S1001 and the values of Tr_{VP(run)} and Tr_{VW(run)} determined in step S1003. Accordingly, the position and orientation Tr_{RW(run)} of the work 5 in the robot coordinate system 101 can be determined.

Tr_{RW(run)}=Tr_{RP}·Tr_{VP(run}⁻¹·Tr_{VW(run)} (2)

The equation (2) holds on the premise that the position and orientation of the pallet 8 are consistent between the time of measurement without change in the position and orientation of the measurement apparatus 2 and the time of measurement with changes in the position and orientation of the measurement apparatus 2. As described above, in the measurement with changes in the position and orientation of the measurement apparatus 2, there is an issue that the position and orientation of the robot 3 cannot be acquired or can be acquired with lack of accuracy. According to the embodiment, however, regardless of whether the position and orientation of the hand 4 on the move can be acquired, it is possible to acquire the position and orientation of the work 5 in the robot coordinate system 101 with the movement of the measurement apparatus 2. This can be achieved by focusing on the point that the measurement apparatus 2 in the stationary state can measure accurately the position and orientation of the hand 4 and the position and the orientation of the pallet 8 in the robot coordinate system 101. In addition, this can be achieved by focusing on the point that, unless the pallet 8 moves from the position of the stationary measurement time at the time of moving measurement, the measurement result obtained by the stationary measurement can be used for the measurement of the work 5 in the same field of view.

The value of Tr_{RW(run)} determined by the three-dimensional information calculation unit 204 is sent to the controller 7, for example. The controller 7 controls the robot 3 such that the hand 4 takes the position and orientation indicated by the value of Tr_{RW(run)} received from the three-dimensional information calculation unit 204 to proceed with the process by causing the hand 4 to grasp the work 5 or the like.

### <Step S1005>

The control unit 201 determines whether the termination condition for the processing in the flowchart of FIG. 3 is satisfied. For example, the control unit 201 determines that the termination condition is satisfied when all the work 5 is completely assembled or the user issues a termination instruction via a user interface not illustrated.

When the control unit 201 determines that the termination condition is satisfied, the process according to the flowchart of FIG. 3 is terminated. Meanwhile, when the control unit 201 does not determine that the termination condition is satisfied, the process goes to step S1002 to perform step S1002 and the subsequent steps on other work 5.

Performing the steps according to the flowchart of FIG. 3 makes it possible to derive the accurate position and orientation of the work 5 in the robot coordinate system 101 even if the accurate position and orientation of the hand 4 with changes in position and orientation cannot be acquired in step S1002 and the subsequent steps. In addition, once steps S1000 and S1001 are performed, the accurate position and orientation of the work 5 in the robot coordinate system 101 can be derived without having to stop the robot 3 later and the work 5 can be grasped and assembled.

Naturally, the accurate position and orientation of the work 5 in the robot coordinate system 101 can be measured and obtained by the measurement apparatus 2 in the stationary state. However, in the production process where a plurality of pieces of work 5 in bulk is repeatedly measured and grasped one by one, an individual piece of work 5 to be shot and recognized vary from one to another, and the state of the bulk may be changed by the physical action of grasping. If the measurement apparatus 2 in the moving state measures the work 5 according to the conventional technique, the position and orientation of the work 5 in the robot coordinate system 101 may not be obtained. From this point of view, to measure and grasp reliably the plurality of pieces of work 5 in bulk every time, the measurement apparatus 2 in the stationary state needs to measure the work 5 every time before grasping the work 5. According to the embodiment, however, once the measurement apparatus 2 in the stationary state measures the work 5, the measurement apparatus 2 in the moving state can reliably measure and grasp the work 5 in bulk later at the time of repeatedly measuring and grasping the work 5. In the production process, the machine vision system 1 according to the embodiment obviously holds superiority in production efficiency at the time of measurement and grasping.

### Second Embodiment

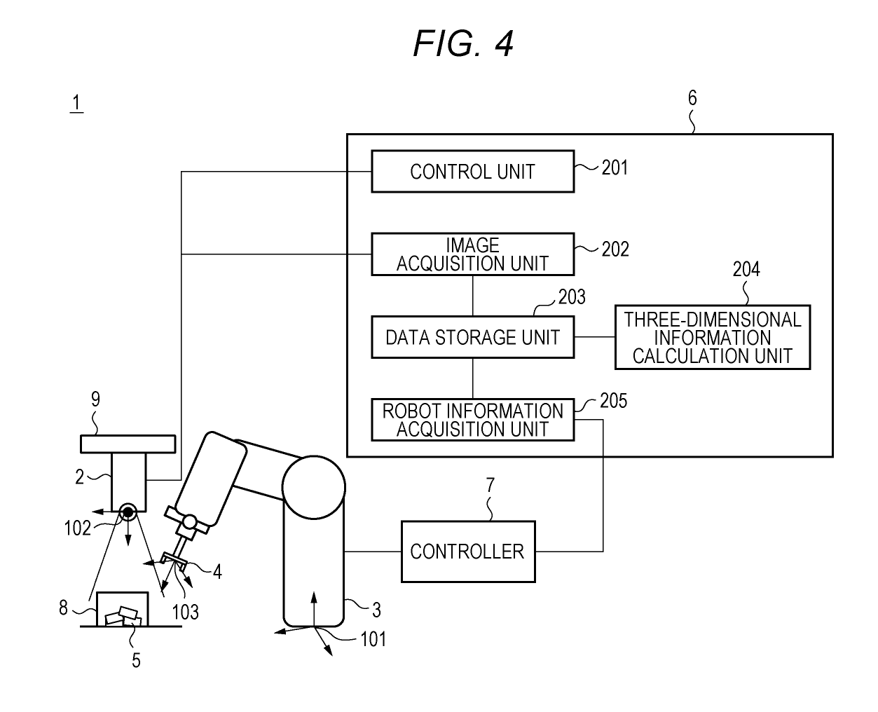

Other embodiments including a second embodiment will be described below with emphasis on the differences from the first embodiment. Unless otherwise specified in the following description, the other embodiments are similar to the first embodiment. Although the measurement apparatus 2 is attached to the robot 3 in the first embodiment, the measurement apparatus 2 may not be necessarily attached to the robot 3 as far as the measurement apparatus 2 is provided in such a manner as to be changeable in position and orientation. For example, as illustrated in FIG. 4, the position and orientation of the measurement apparatus 2 may be changed by a driving mechanism 9 such as a moving stage or an electric slider.

In such a case, in step S1000, the driving mechanism 9 fixes the position and orientation of the measurement apparatus 2 such that the pallet 8 falls within the ranges of pattern projecting and image shooting by the measurement apparatus 2. Then, the measurement apparatus 2 outputs to the information processing apparatus 6 the shot image of the pallet 8 on which the projection pattern is projected as in the first embodiment, and the image acquisition unit 202 acquires the shot image sent by the measurement apparatus 2 and stores the same in the data storage unit 203.

In step S1001, as in the first embodiment, the three-dimensional information calculation unit 204 determines the matrix representing the position and orientation of the pallet 8 in the vision coordinate system 102 as Tr_{VP(stop)}. The position and orientation of the measurement apparatus 2 in the robot coordinate system 101 are determined as matrix Tr_{RV} in advance at the time of calibration. At that time, the three-dimensional information calculation unit 204 calculates the matrix Tr_{RP} indicating the position and orientation of the pallet 8 in the robot coordinate system 101 according to the following equation (3):

Tr_{RP}=Tr_{RV}·Tr_{VP(stop)} (3)

The subsequent steps are the same as those in the first embodiment.

### Third Embodiment

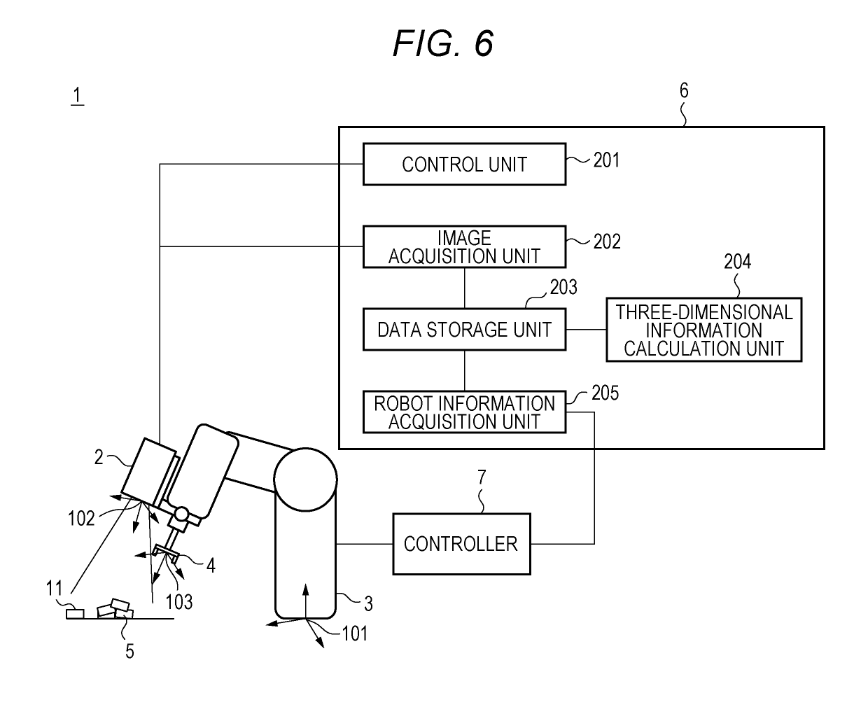

Although the pallet 8 is used as a stationary object in the first embodiment, another object may be used as a stationary object. For example, as illustrated in FIG. 6, fixed work 11 to be unchanged in position and orientation may be used as a stationary object. The fixed work 11 may be of the same kind as the work 5 or may be another kind of object with higher recognition accuracy. In an assembly process as a purpose of operating the robot, for example, the work 5 may be grasped and assembled into destination work, component, housing, or the like. In such a case, the position of the work 5 in bulk is unfixed but the position of the assembly destination may be fixed and unchanged in the robot coordinate system in the assembly process. In this case, the work or housing as the assembly destination may be employed as fixed work 11. In addition, the fixed work 11 may not be a measurement target to be actually measured for the purpose of grasping and assembly at a production site but may be a separately provided recognition marker. The marker can take various modes as far as it can be measured by the measurement apparatus 2. Nevertheless, it is desired to select a rigidly fixed marker so as not to change in position and orientation or a marker with high accuracy of recognition by the measurement apparatus 2.

### Fourth Embodiment

In the first embodiment, it is assumed to use the method for the measurement apparatus 2 to measure three-dimensional information of a measurement target by which to project the projection pattern with dots on lines onto the measurement target, shoot the measurement target on which the projection pattern is projected, and obtain the three-dimensional information from the shot image. However, various other methods for measuring three-dimensional information on a measurement target can be employed. For example, a one-shot measurement method may be employed to obtain three-dimensional information of a measurement target by the measurement apparatus 2 shooting once the measurement target. As other examples, a line-width modulation method by which the line widths are varied for identification of the lines in the projection pattern may be employed, or a random-dot method by which randomly-arranged dots are projected may be employed. In addition, besides the pattern projection methods, a passive stereo measurement method may be employed to shoot a measurement target by two cameras and obtain three-dimensional information by using parallax. In this manner, various sensors are applicable to the measurement apparatus 2 to measure the position and orientation of a measurement target.

### Fifth Embodiment

In step S1000, the measurement target is shot with the hand 4 and the measurement apparatus 2 fixed in position and orientation. However, the hand 4 and the measurement apparatus 2 may not be completely stopped if the position and orientation of the hand 4 in proximity can be acquired at the time of image shooting.

For example, when the interval between outputs of position and orientation from the controller 7 is short relative to the moving speed of the hand 4, the position and orientation of the hand 4 acquired behind the shooting timing (measurement timing) may not be greatly different from the true value of the position and orientation of the hand 4 at the shooting time. That is, when the position and orientation of the hand 4 can be obtained such that the difference from the position and orientation of the hand 4 at the shooting time falls within a prescribed range even if the hand 4 is moved at the first moving speed, steps S1000 and S1001 may be performed while the hand 4 is moved at the first moving speed.

This is applicable to the measurement apparatus 2. The measurement apparatus 2 may not be necessarily fixed in position in step S1000 in the second embodiment. That is, when the position and orientation of the measurement apparatus 2 can be obtained such that the difference from the position and orientation of the measurement apparatus 2 at the shooting time falls within a prescribed range even if the measurement apparatus 2 is moved at the first moving speed, steps S1000 and S1001 may be performed while the measurement apparatus 2 is moved at the first moving speed.

### Sixth Embodiment

In a six embodiment, a switchover takes place between the determination of the position and orientation of the work 5 in the robot coordinate system 101 by employing the configuration of the first embodiment and the measurement of the position and orientation of the work 5 in the robot coordinate system 101 while moving the hand 4 without determining the position and orientation of the pallet 8 in the robot coordinate system 101. Whether the position and orientation of the robot 3 can be acquired at the time of image shooting by the measurement apparatus 2 depends on various parameters such as the moving speed of the hand 4, the exposure time of the measurement apparatus 2, and the performance of the information processing apparatus 6. Accordingly, in the situation where the position and orientation of the hand 4 at the shooting time can be reliably acquired by empirical means or from the result of calculation of the acquiring timing, the result of the measurement by the measurement apparatus 2 on the move can be employed without performing the steps in the flowchart of FIG. 3 from the viewpoint of improving throughput. Various modification examples of the sixth embodiment will be described below.

### MODIFICATION EXAMPLE 1

In modification example 1, the foregoing switchover occurs in accordance with the setting information of the moving speed of the hand 4. As described above, in some cases, the position and orientation of the hand 4 cannot be acquired in the situation where the hand 4 is moving at a high speed. If the reason for that is the receipt of the next trigger before the position and orientation of the hand 4 acquired by the controller 7 are completely written into the memory as described above, the position and orientation of the hand 4 can be obtained when the moving speed of the hand 4 is slow. It has been experimentally observed in some cases that the position and orientation of the hand 4 can be acquired when the moving speed of the hand 4 is slower than a specific speed. Accordingly, when the speed of the hand 4 is slower than a specific speed, the measurement may be made through acquisition of the position and orientation of the hand 4 by the controller 7 as usual, and when the speed of the hand 4 is faster than a specific speed, the measurement may be made employing the configuration according to the first embodiment.

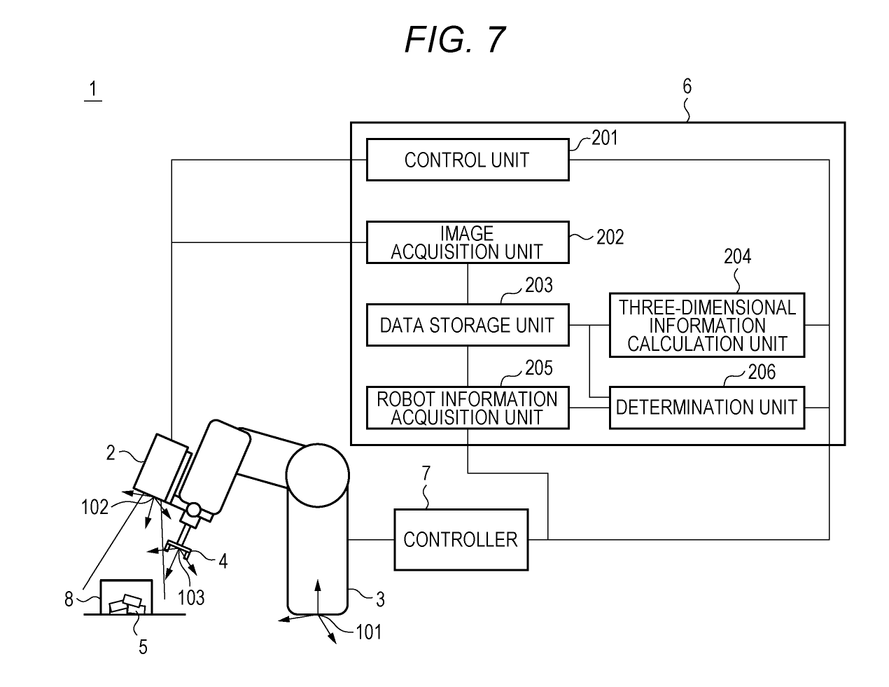

FIG. 7 illustrates a configuration example of the machine vision system 1 according to modification example 1. In the configuration illustrated in FIG. 7, a determination unit 206 is added to the information processing apparatus 6 in the configuration illustrated in FIG. 1. The determination unit 206 compares the moving speed of the hand 4 indicated by the setting information obtained from the controller 7 to a speed threshold stored in advance in the data storage unit 203.

When the determination unit 206 determines that the moving speed of the hand 4 is higher (faster) than the speed threshold as a result of the comparison, the position and orientation of the hand 4 may not be accurately acquired from the controller 7 at the time of image shooting. Accordingly, in order to implement the measurement described above in relation to the first embodiment, the determination unit 206 sends to the controller 7 a control signal to control the position and orientation of the hand 4 for the processing in accordance with the flowchart of FIG. 3.

Meanwhile, when the determination unit 206 determines that the moving speed of the hand 4 is lower (slower) than the speed threshold as a result of the comparison, the position and orientation of the hand 4 can be accurately acquired from the controller 7 at the time of image shooting. Accordingly, the determination unit 206 sends to the controller 7 a control signal for moving the hand 4. The image acquisition unit 202 acquires the image shot by the measurement apparatus 2 on the move. The three-dimensional information calculation unit 204 calculates from the shot image the determinant of matrix Tr_{VW(run)} indicating the position and orientation of the work in the vision coordinate system 102. The robot information acquisition unit 205 acquires from the controller 7 the determinant of matrix Tr_{RH(run)} representing the position and orientation of the hand 4 in the robot coordinate system 101. The three-dimensional information calculation unit 204 calculates the following equation (4) to determine the matrix Tr_{RW(run)} representing the position and attribute of the work 5 in the robot coordinate system 101.

Tr_{RW(run)}=Tr_{RH(run)}·Tr_{HV}·Tr_{VW(run)} (4)

Tr_{HV} denotes the matrix representing the position and orientation of the vision coordinate system 102 with reference to the hand coordinate system 103 (the position and orientation of the measurement apparatus 2 in the hand coordinate system 103), which is registered in the data storage unit 203 as described above in relation to the first embodiment.

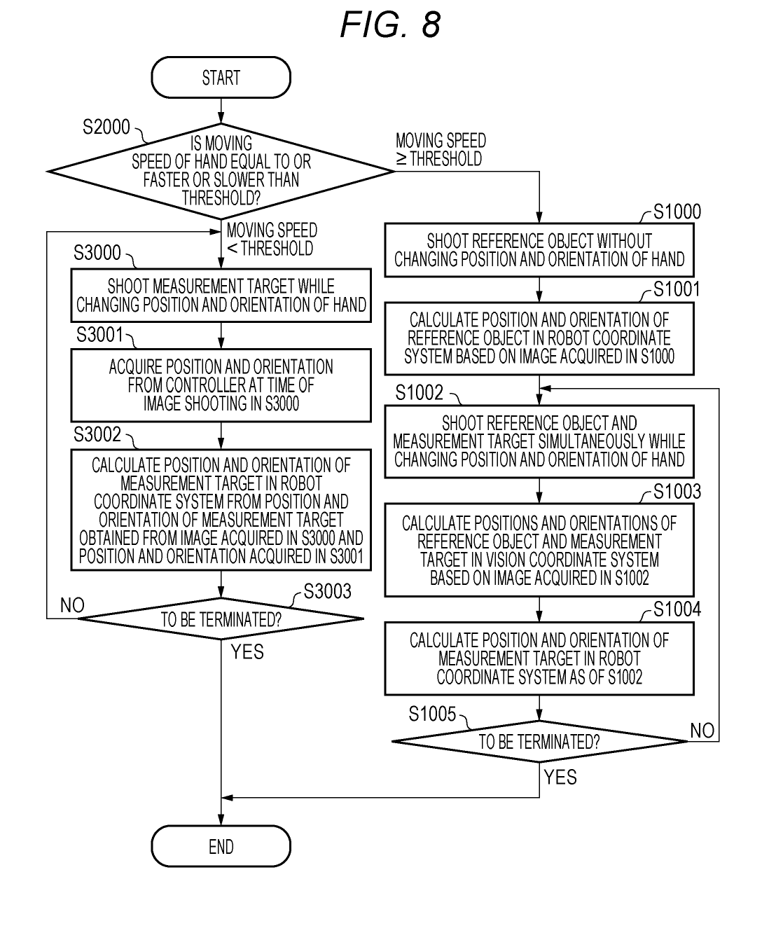

Processing performed by the information processing apparatus 6 in the machine vision system 1 according to modification example 1 to determine the position and orientation of the work 5 in the robot coordinate system 101 will be described with reference to the flowchart of FIG. 8. In FIG. 8, the same processing steps as those described in FIG. 3 are given the same step numbers, and descriptions thereof are omitted.

### <Step S2000>

The determination unit 206 compares the moving speed of the hand 4 indicated by the setting information obtained from the controller 7 to the speed threshold stored in advance in the data storage unit 203. When the determination unit 206 determines that the moving speed of the hand 4 is higher (faster) than the speed threshold as a result of the comparison, the process goes to step S1000. Meanwhile, when the determination unit 206 determines that the moving speed of the hand 4 is lower (slower) than the speed threshold as a result of the comparison, the process goes to step S3000.

### <Step S3000>

Since the hand 4 is moved by the controller 7, the measurement apparatus 2 shoots the work 5 while moving as well. Accordingly, the image acquisition unit 202 acquires the image shot by the measurement apparatus 2 on the move.

### <Step S3001>

The robot information acquisition unit 205 acquires from the controller 7 the determinant of matrix Tr_{RH(run)} representing the position and orientation of the hand 4 in the robot coordinate system 101.

### <Step S3002>

The three-dimensional information calculation unit 204 calculates the determinant of matrix Tr_{VW(run)} representing the position and orientation of the work 5 in the vision coordinate system 102 from the shot image acquired in step S3000. The three-dimensional information calculation unit 204 then calculates the foregoing equation (4) by using the values of Tr_{VW(run)}, Tr_{RH(run)} acquired in step S3001, and Tr_{HV} acquired from the data storage unit 203. Accordingly, the three-dimensional information calculation unit 204 determines the matrix Tr_{RW(run)} representing the position and orientation of the work 5 in the robot coordinate system 101.

### <Step S3003>

The control unit 201 determines whether the termination condition for the processing in the flowchart of FIG. 8 is satisfied. When the control unit 201 determines that the termination condition is satisfied, the process according to the flowchart of FIG. 8 is terminated. Meanwhile, when the control unit 201 does not determine that the termination condition is satisfied, the process goes to step S3000 to perform step S3000 and the subsequent steps on other work 5, for example.

In step S2000, it may be determined whether to perform steps S1000 to S1005 or perform steps S3000 to S3003 with consideration given to the exposure time of the measurement apparatus 2, and the performance of the information processing apparatus 6 in addition to or instead of the moving speed of the hand 4.

The determination in step S2000 is performed before the measurement of the measurement target as described in FIG. 8 when the moving speed of the hand 4 is unchanged during the measurement. However, when the moving speed of the hand 4 is changed during the measurement, the moving speed of the hand 4 may be monitored in real time so that the determination in step S2000 can be performed at each measurement.

### MODIFICATION EXAMPLE 2

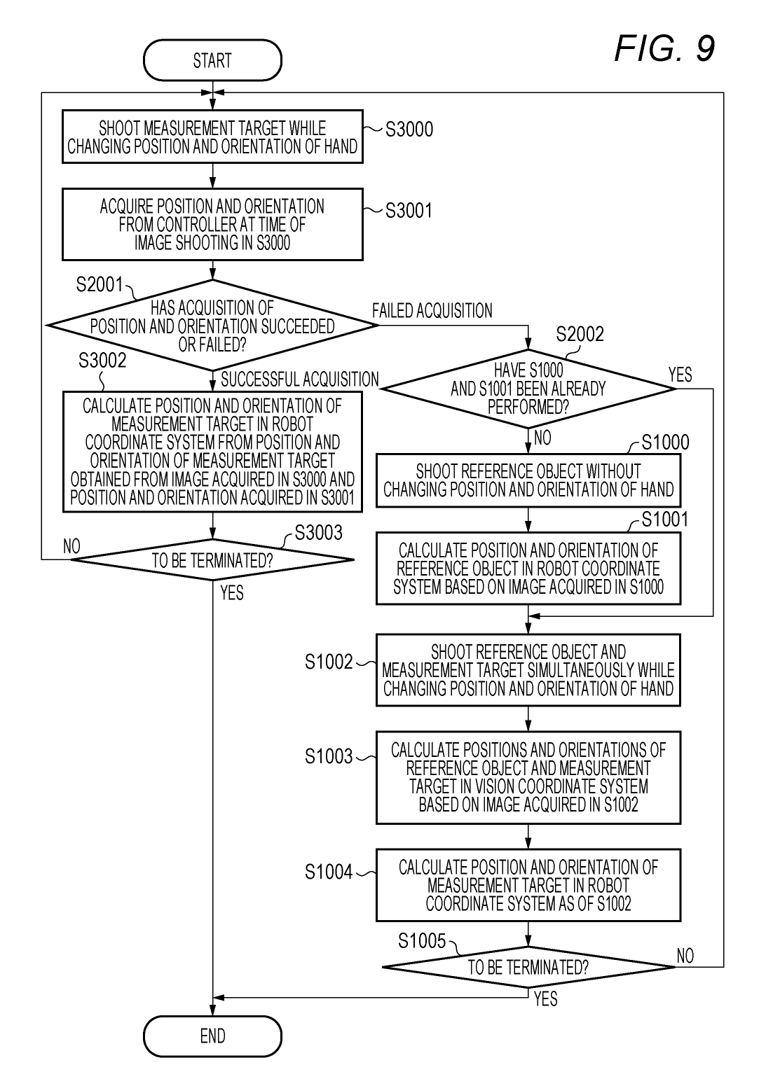

In modification example 2 as well, the machine vision system 1 configured as illustrated in FIG. 7 is used. Processing performed by the information processing apparatus 6 in the machine vision system 1 according to modification example 2 to determine the position and orientation of the work 5 in the robot coordinate system 101 will be described with reference to the flowchart of FIG. 9. The same processing steps described in FIG. 9 as those described in FIGS. 3 and 8 are given the same step numbers as those described in FIGS. 3 and 8, and detailed descriptions thereof are omitted. The flow of the processing will be basically described below.

In step S2001, the determination unit 206 determines whether the robot information acquisition unit 205 has acquired from the controller 7 the determinant of matrix Tr_{RH(run)} representing the position and orientation of the hand 4 at the timing of acquiring the shot image in step S3000. When the determination unit 206 determines that the robot information acquisition unit 205 has acquired the determinant of matrix, the acquisition is determined as successful and the process goes to step S3002. Meanwhile, when the determination unit 206 does not determine that the robot information acquisition unit 205 has acquired the determinant of matrix, the acquisition has failed, and the process goes to step S2002.

For example, it is assumed that the measurement is made with the hand 4 moved at a low speed so that the position and orientation of the hand 4 can be stably acquired from the controller 7. Even in that case, the position and orientation of the hand 4 may not be acquired under such a condition as fluctuation in the processing speed of the controller 7 or a shift of the acquisition timing. At that time, causing a transition to the measurement method in the first embodiment with the incapability of acquiring the position and orientation of the hand 4 as a criterion of determination would enable various actions such as grasping and assembly while minimizing reduction of throughput involved in the application of the first embodiment from the beginning.

In step S2002, the determination unit 206 determines whether steps S1000 and S1001 have been already performed to acquire the position and orientation of the pallet 8 in the robot coordinate system 101 and store the same in the data storage unit 203. When the determination unit 206 determines that steps S1000 and S1001 have been already performed, the process goes to step S1002. Meanwhile, when the determination unit 206 determines that steps S1000 and S1001 have not yet been performed, the process goes to step S1000.

As described above, it is assumed in modification example 2 that the failure of acquisition determined in step S2001 is an irregular case, and it is thus likely that the successful result will be achieved in step S2001 next time and from then onward. Even if the result is a failure in step S2001, performing steps S1000 and S1001 once would eliminate the need to make measurements later with the robot 3 in the stationary state. When it is determined in step S3003 or 51005 that the termination condition is not satisfied, the process goes to step S3000.

### MODIFICATION EXAMPLE 3

In modification example 3, it is assumed that the moving speed of the hand 4 is fast and the position and orientation of the hand 4 cannot be acquired sometimes. In such a case, the measurement method according to the first embodiment is desirably employed. As described above, the first embodiment is based on the premise that the pallet 8 as a stationary object is not changed in position and orientation during the measurement of the position and orientation of the pallet 8 in the robot coordinate system 101 and the measurement of the position and orientation of the work 5 in the robot coordinate system 101. The pallet is basically not subjected to physical interference during the measurement, and thus the foregoing premise holds in many situations. However, the position and orientation of the pallet 8 may be changed due to the motion of the robot 3 caused by wrong recognition, the indirect physical action of the work 5 grasped in the pallet 8, or the like. In such cases, it is not possible to perform various actions such as grasping and assembly of the work 5 by the measurement method according to the first embodiment.

Accordingly, when the position and orientation of the pallet 8 are changed as described above, it is desired to switch to measurement conditions under which the pallet can be accurately measured again. To achieve such a switchover in the measurement flow, it is necessary to determine whether the position and orientation of the pallet 8 have been changed.

In modification example 3 as well, the machine vision system 1 configured as illustrated in FIG. 7 is used. Steps S1000 and S1001 described above in relation to the first embodiment are performed to acquire the matrix Tr_{RP(stop)} representing the position and orientation of the pallet 8 in the robot coordinate system 101 in the data storage unit 203.

The matrix Tr_{VP(run)} representing the position and orientation of the pallet 8 in the vision coordinate system 102 measured by the measurement apparatus 2 while moving the hand 4 is obtained. The matrix Tr_{HV} representing the position and orientation of the vision coordinate system 102 with reference to the hand coordinate system 103 (the position and orientation of the measurement apparatus 2 in the hand coordinate system 103) is registered in advance in the data storage unit 203. The matrix Tr_{RH(run)} representing the position and orientation of the hand 4 in the robot coordinate system 101 at the time of measurement by the measurement apparatus 2 is acquired by the robot information acquisition unit 205 from the controller 7. At that time, the following equation (5) is calculated by using the matrixes Tr_{VP(run)}, Tr_{HV} and Tr_{RH(run)}. Accordingly, the matrix Tr_{RP(run)} representing the position and orientation of the pallet 8 in the robot coordinate system 101 can be determined.

Tr_{RP(run)}=Tr_{RH(run)}·Tr_{HV}·Tr_{VP(run)} (5)

At this point in time, the measurement result Tr_{RP(stop)} of the position and orientation of the pallet 8 in the robot coordinate system 101 without movement of the measurement apparatus 2 and the measurement result Tr_{RP(run)} of the position and orientation of the pallet 8 in the robot coordinate system 101 with movement of the measurement apparatus 2 are acquired.

When the difference between Tr_{RP(stop)} and Tr_{RP(run)} is less than a prescribed amount, it is reasonably determined that the accurate position and orientation of the hand 4 in the robot coordinate system 101 have been acquired and the position and orientation of the pallet 8 have not been changed.

Meanwhile, when the difference between Tr_{RP(stop)} and Tr_{RP(run)} is equal to or larger than a specific amount, there are two possible causes of it. One of them is that the value of Tr_{RH(run)} cannot be accurately acquired, and the other is that the position and orientation of the pallet 8 have been changed. The actual cause can be identified between the two based on the shift of the position and orientation of the pallet 8 resulting from physical interference with the accuracy of Tr_{RH(run)}. When it is empirically known that the position and orientation of the hand 4 on the move can be acquired only with a shift of 100 μm or so, the occurrence of a larger shift, for example, a shift of several mm, could be attributed to the change in the position and orientation of the pallet 8. As an alternative method for identifying the other cause, the direction of the shift can be used. For example, when the trajectory of the movement of the hand 4 is known, it is likely that the direction of the vector of error in acquisition of the position information of Tr_{RH(run)} aligns with the direction of the vector of the trajectory. Accordingly, it can be determined that the value of Tr_{RH(run)} have not been accurately acquired if the direction of the shift aligns with the direction of the trajectory, whereas it can be determined that the position and orientation of the pallet 8 have been changed if the difference between the two directions is larger than a predetermined threshold. When it is determined that the position and orientation of the pallet 8 have been changed by the foregoing determination, the process according to the flowchart of FIG. 3 is performed again.

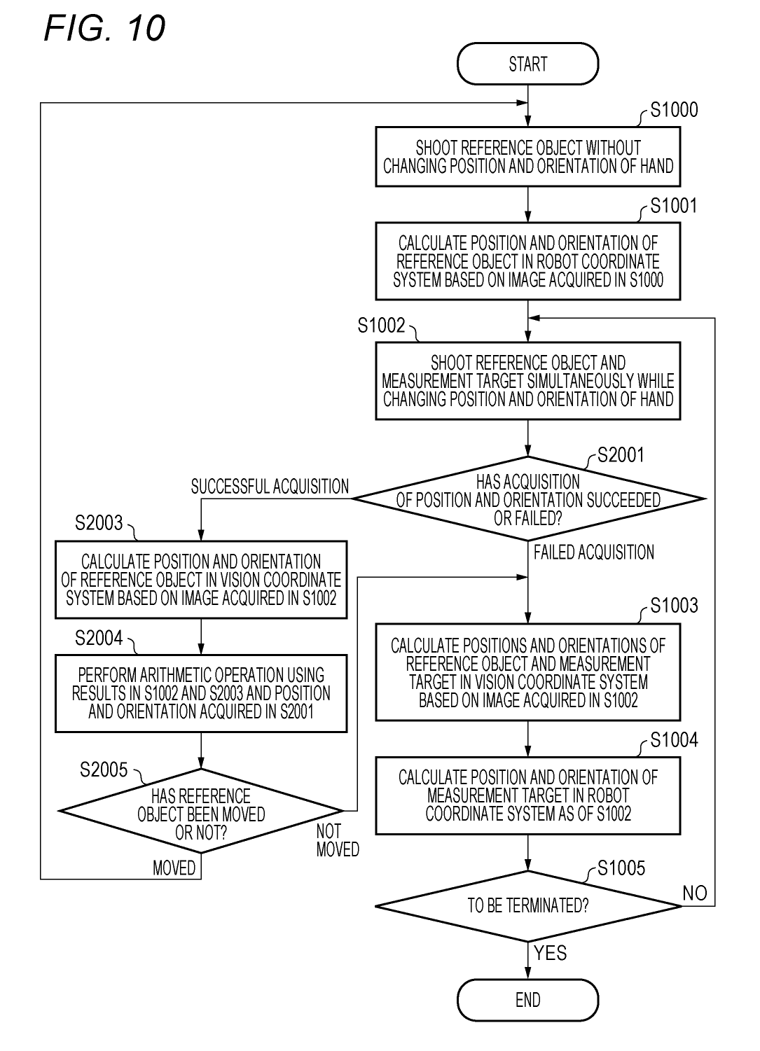

Processing performed by the information processing apparatus 6 in the machine vision system 1 according to modification example 3 to determine the position and orientation of the work 5 in the robot coordinate system 101 will be described with reference to the flowchart of FIG. 10. The same processing steps described in FIG. 10 as those described in FIGS. 3, 8, and 9 are given the same step numbers as those described in FIGS. 3, 8, and 9, and detailed descriptions thereof are omitted. The flow of the processing will be basically described below.

In step S2001, the determination unit 206 determines whether the robot information acquisition unit 205 has acquired the determinant of matrix Tr_{RH(run)} representing the position and orientation of the hand 4 from the controller 7 at the timing when the shot image was acquired in step S1002. When the determination unit 206 determines that the robot information acquisition unit 205 has acquired the determinant of matrix, the determination unit 206 determines that the acquisition has succeeded, and the process goes to step S2003. Meanwhile, when the determination unit 206 does not determine that the robot information acquisition unit 205 has acquired the determinant of matrix, the determination unit 206 determines that the acquisition has failed, and the process goes to step S1003.

In step S2003, the three-dimensional information calculation unit 204 determines the position and orientation of the pallet 8 in the vision coordinate system 102 based on the shot image acquired in step S1002. In step S2004, the three-dimensional information calculation unit 204 determines the position and orientation of the pallet 8 in the robot coordinate system 101 at the time of image shooting in step S1000 by using the foregoing equation (5).

In step S2005, the determination unit 206 compares the position and orientation of the pallet 8 in the robot coordinate system 101 calculated in step S1001 to the position and orientation of the pallet 8 in the robot coordinate system 101 calculated in step S2004. As described above, when the difference between the two is found to be equal to or greater than the threshold as a result of the comparison, the determination unit 206 determines that the position and orientation of the pallet 8 have been changed and the process returns to step S1000. When the difference between the two is equal to or greater than the threshold, the process may not necessarily go to step S1000. For example, when the position and orientation of the hand 4 acquired in step S2001 are of high accuracy, the position and orientation of the pallet 8 determined in step S2004 may be regarded as the position and orientation of the pallet 8 after the movement, and the process may go to step S1003. Meanwhile, when the difference between the two is found to be smaller than the threshold, the determination unit 206 determines that the position and orientation of the pallet 8 have not been changed and the process goes to step S1003.

In modification example 3, the presence or absence of change in the position and orientation of the pallet 8 is determined based on the position and orientation of the pallet 8 in the robot coordinate system 101. Alternatively, the presence or absence of change in the position and orientation of the pallet 8 may be determined by using another method. For example, the position and orientation of the hand 4 at the timing of image shooting with change in the position and orientation of the measurement apparatus 2 may be calculated backwards based on the assumption that the position and orientation of the pallet 8 are unchanged. In addition, the presence or absence of change in the position and orientation of the pallet 8 can also be determined by determining whether the position and orientation of the hand 4 calculated backwards are reliable in the trajectory of the hand 4.

Some or all of the foregoing embodiments may be combined as appropriate. For example, in the foregoing embodiments, the measurement is made without changing the position and orientation of the hand 4 and then the measurement is made while changing the position and orientation of the hand 4, but this order may be variable. That is, the position and orientation of a reference object unchanged in position and orientation in the robot coordinate system are measured both in the accurately acquirable state and the moving state, and the measurement result is used to acquire in the moving state the position and orientation of a measurement target to be grasped or assembled in the robot coordinate system.

In the foregoing embodiments, the hand 4 is attached to the robot 3 and the controller 7 acquires the position and orientation of the hand 4 in the robot coordinate system 101. However, when some unit other than the hand 4 is attached to the robot 3, the position and orientation of that unit are used instead of the position and orientation of the hand 4 in the foregoing processing. Alternatively, an arbitrary region of the robot 3 may be targeted in place of such a unit.

### Seventh Embodiment

The functional units constituting the information processing apparatus 6 illustrated in FIGS. 1, 4, 6, and 7 may be implemented as hardware, or all the functional units except for the data storage unit 203 may be implemented as software (computer programs). In the latter case, a computer device having a memory serving as the data storage unit 203 and a processor capable of executing computer programs corresponding to the other functional units is applicable to the information processing apparatus 6.

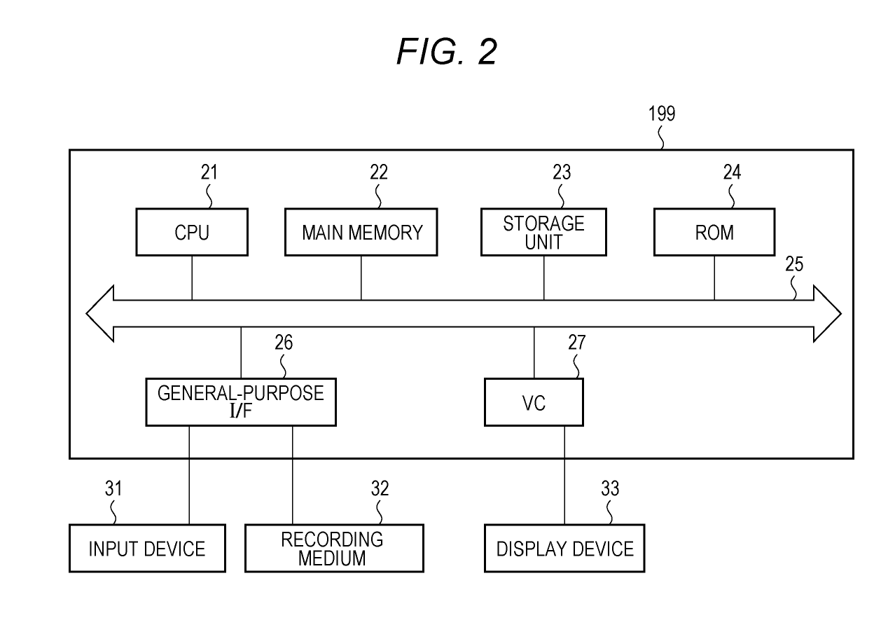

A hardware configuration example of a computer device 199 applicable to the information processing apparatus 6 will be described with reference to the block diagram of FIG. 2. The configuration illustrated in FIG. 2 is an example of hardware configuration of a computer device applicable to the information processing apparatus 6 and can be modified and altered in various manners.

A CPU 21 performs processing with the computer programs and data stored in a main memory 22. Accordingly, the CPU 21 controls the entire operations of the computer device 199 and performs or controls the processes described above as being performed by the information processing apparatus 6.

The main memory 22 has an area for storing computer programs and data loaded from a storage unit 23 and a ROM 24 and computer programs and data loaded from a recording medium 32 via a general-purpose I/F 26. The main memory 22 further has a work area used by the CPU 21 to perform or control the various processes. In this manner, the main memory 22 can provide various areas as appropriate.

The storage unit 23 is a large-capacity information storage unit typified by a hard disk drive. The storage unit 23 saves an operating system (OS) and computer programs and data for the CPU 21 to perform or control the processes described above as being performed by the information processing apparatus 6. The computer programs saved in the storage unit 23 include the computer programs for the CPU 21 to perform the functions of the functional units except for the data storage unit 203 illustrated in FIGS. 1, 4, 6, and 7. The data saved in the storage unit 23 includes the information described above as being known, for example, thresholds, the matrix Tr_{HV}, the matrix Tr_{RV}, and others. The computer programs and data saved in the storage unit 23 are loaded as appropriate into the main memory 22 under the control of the CPU 21, and are processed by the CPU 21. The ROM 24 saves boot programs, setting data, and others.

The general-purpose I/F 26 connects to an input device 31 and the recording medium 32. The input device 31 includes user interfaces such as a keyboard and a mouse, which are operated by the user to input various instructions into the CPU 21. The recording medium 32 is a memory such as an SD card or a USB.

A video controller (VC) 27 connects to a display device 33. The display device 33 can display the results of processing by the CPU 21 in images, characters, and the like under the control of the VC 27. The input device 31 and the display device 33 may be integrated into a touch panel screen. The CPU 21, the main memory 22, the storage unit 23, the ROM 24, the general-purpose I/F 26, and the VC 27 are connected to a bus 25.

### Eighth Embodiment

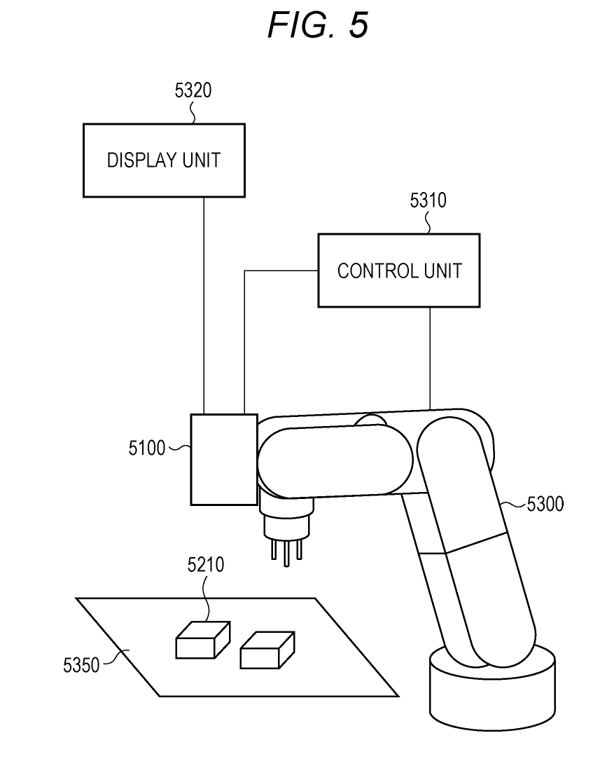

A measurement apparatus including the information processing apparatus 6 and the measurement apparatus 2 can be used in the state of being supported by a support member. In relation to an eighth embodiment, as an example, a control system included in a robot arm 5300 (grasping apparatus) to be used as illustrated in FIG. 5 will be described. A measurement apparatus 5100 projects pattern light onto a target 5210 placed on a support stage 5350, and shoots the same and acquires an image. Then, a control unit of the measurement apparatus 5100 or a control unit 5310 having acquired image data from the control unit of the measurement apparatus 5100 determines the position and orientation of the target 5210, and the control unit 5310 acquires information on the determined position and orientation. The control unit 5310 sends a driving instruction to the robot arm 5300 based on the information on the position and orientation to control the robot arm 5300. The robot arm 5300 holds the target 5210 by a leading-end robot hand (grasping unit) and moves the target 5210 by translation, rotation, or the like. The target 5210 can be assembled into another component by using the robot arm 5300 to manufacture products from a plurality of components, such as electronic circuit substrates or machinery, for example. In addition, the moved target 5210 can be machined to produce products. The control unit 5310 has an arithmetic unit such as a CPU and a storage unit such as a memory. A control unit for controlling the robot may be provided outside the control unit 5310. In addition, the data of measurement made by the measurement apparatus 5100 and the images obtained by the measurement apparatus 5100 may be displayed on a display unit 5320 such as a display.

### OTHER EXAMPLES

Embodiments of the present invention can be implemented by supplying programs implementing one or more of the functions in the foregoing embodiments to a system or a device via a network or a storage medium so that one or more processors in a computer in the system or the device can read and execute the programs. Alternatively, embodiments of the present invention can be implemented by a circuit performing one or more of the functions (for example, ASIC).

According to the configuration of embodiments of the present invention, it is possible to determine the accurate position and orientation of a measurement target while moving.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-059688, filed Mar. 24, 2017, which is hereby incorporated by reference herein in its entirety.

What is claimed is:

1. An information processing apparatus comprising:
a first obtaining unit configured to obtain, based on the result of measurement of position and orientation of a stationary object by a sensor attached to a robot moving at a first speed and the position and orientation of the robot in a reference coordinate system acquired during the measurement, the position and orientation of the stationary object in the reference coordinate system; and
a second obtaining unit configured to obtain, based on the result of measurement of positions and orientations of the stationary object and a target object by the sensor attached to the robot moving at a second speed higher than the first speed and the position and orientation of the stationary object obtained by the first obtaining unit, the position and orientation of the target object in the reference coordinate system.

2. The information processing apparatus according to claim 1, wherein the first obtaining unit obtains the position and orientation of the stationary object in a coordinate system with reference to the sensor based on the result of measurement of position and orientation of the stationary object by the sensor attached to the robot moving at the first speed, and obtains the position and orientation of the stationary object in the reference coordinate system based on the obtained position and orientation of the stationary object in the coordinate system with reference to the sensor, the position and orientation of the robot in the reference coordinate system acquired during the measurement, and a relationship in relative position and orientation between the robot and the sensor.

3. The information processing apparatus according to claim 2, wherein the second obtaining unit obtains the position and orientation of the target object in the reference coordinate system based on the position and orientation of the target object in the coordinate system determined based on the result of measurement of the target object by the sensor at the second speed, the position and orientation of the stationary object in the coordinate system obtained based on the result of measurement of the stationary object by the sensor at the second speed, and the position and orientation obtained by the first obtaining unit.

4. The information processing apparatus according to claim 1, wherein the first speed is zero.

5. The information processing apparatus according to claim 1, wherein the stationary object is a container that contains the target object.

6. The information processing apparatus according to claim 1, wherein the stationary object is to be assembled by the robot.

7. The information processing apparatus according to claim 1, wherein the stationary object is a marker.

8. The information processing apparatus according to claim 1, further comprising:
a determination unit configured to determine whether the robot moves faster or slower than a speed threshold,
wherein the second obtaining unit operates when the second speed of the robot is faster than the speed threshold.

9. The information processing apparatus according to claim 1, further comprising:
a unit configured to determine whether the acquisition of position and orientation of the robot during the measurement by the sensor on the move has succeeded or failed,
wherein the first obtaining unit and the second obtaining unit operate when the acquisition of position and orientation of the robot during the measurement by the sensor on the move has failed.

10. The information processing apparatus according to claim 1, further comprising:
a determination unit configured to determine whether the position and orientation determined by the first obtaining unit have been changed,
wherein, when the position and orientation determined by the first obtaining unit have been changed, the first obtaining unit performs the process again.

11. The information processing apparatus according to claim 1, wherein the first speed is a speed at which the position and orientation of the robot in the reference coordinate system are acquirable at timing for measurement by the sensor attached to the robot.

12. A system comprising:
the information processing apparatus according to claim 1; and
the robot configured to hold and move the target object based on the result of measurement by the information processing apparatus.

13. The system according to claim 12, further comprising:
the sensor configured to measure the position and orientation of an object.

14. A system comprising:
a sensor; and
a first obtaining unit configured to obtain, based on the result of measurement of position and orientation of a stationary object by the sensor attached to a robot moving at a first speed and the position and orientation of the robot in a reference coordinate system acquired during the measurement, the position and orientation of the stationary object in the reference coordinate system; and
a second obtaining unit configured to obtain, based on the result of measurement of positions and orientations of the stationary object and a target object by the sensor attached to the robot moving at a second speed higher than the first speed and the position and orientation of the stationary object obtained by the first obtaining unit, the position and orientation of the target object in the reference coordinate system.

15. A method for manufacturing a product, comprising the steps of:
measuring a target object by using the information processing apparatus according to claim 1; and
manufacturing a product by processing the target object based on the result of the measurement.

16. An information processing method comprising:
a first obtaining step, performed by an information processing apparatus, of obtaining, based on the result of measurement of position and orientation of a stationary object by a sensor attached to a robot moving at a first speed and the position and orientation of the robot in a reference coordinate system acquired during the measurement, the position and orientation of the stationary object in the reference coordinate system; and
a second obtaining step, performed by the information processing apparatus, of obtaining, based on the result of measurement of positions and orientations of the stationary object and a target object by the sensor in the robot moving at a second speed higher than the first speed and the position and orientation of the stationary object obtained in the first obtaining step, the position and orientation of the target object in the reference coordinate system.

17. A computer-readable storage medium storing executable program instructions, which when executed by one or more processors of an information processing apparatus, cause the information processing apparatus to perform the method of claim 16.

18. An information processing apparatus comprising:
a first obtaining unit configured to obtain, based on the result of measurement of position and orientation of a stationary object by a sensor moving at a first speed and the position and orientation of the sensor in a reference coordinate system acquired during the measurement, the position and orientation of the stationary object in the reference coordinate system; and
a second obtaining unit configured to obtain, based on the result of measurement of positions and orientations of the stationary object and a target object measured by the sensor moving at a second speed higher than the first speed and the position and orientation obtained by the first obtaining unit, the position and orientation of the target object in the reference coordinate system.

19. A system comprising:
a sensor; and
a first obtaining unit configured to obtain, based on the result of measurement of position and orientation of a stationary object by the sensor moving at a first speed and the position and orientation of the sensor in a reference coordinate system acquired during the measurement, the position and orientation of the stationary object in the reference coordinate system; and
a second obtaining unit configured to obtain, based on the result of measurement of positions and orientations of the stationary object and a target object measured by the sensor moving at a second speed higher than the first speed and the position and orientation obtained by the first obtaining unit, the position and orientation of the target object in the reference coordinate system.

20. A method for manufacturing a product, comprising the steps of:
measuring a target object by using the information processing apparatus according to claim 18; and
manufacturing a product by processing the target object based on the result of the measurement.

21. An information processing method comprising:
a first obtaining step, performed by an information processing apparatus, of obtaining, based on the result of measurement of position and orientation of a stationary object by a sensor moving at a first speed and the position and orientation of the sensor in a reference coordinate system acquired during the measurement, the position and orientation of the stationary object in the reference coordinate system; and
a second obtaining step, performed by the information processing apparatus, of obtaining, based on the result of measurement of positions and orientations of the stationary object and a target object by the sensor moving at a second speed higher than the first speed and the position and orientation obtained in the first obtaining step, the position and orientation of the target object in the reference coordinate system.

22. A computer-readable storage medium storing executable program instructions, which when executed by one or more processors of an information processing apparatus, cause the information processing apparatus to perform the method of claim 21.
